(19) United States
(12) Patent Application Publication
(10) Pub. No.: US 2002/0020795 A1
(43) Pub. Date: Feb. 21, 2002

(54) Mounting assembly

(76) Inventors: Sean Crispian Keeping, Shortlands (GB); Cotin Ernest Howell, Eynesbury (GB); Charles Lucas Greensted, Chaltenham (GB); Robert Crowe, Cambridgeshire (GB)

Correspondence Address: LARSON & TAYLOR, PLC, 1199 NORTH FAIRFAX STREET, SUITE 900, ALEXANDRIA, VA, 22314, US

(21) Appl. No.: 09/867,744

(22) Filed: May 31, 2001

(30) Foreign Application Priority Data
May 31, 2000 (GB) 0013211.8

(51) Int. Cl. A47H 1/10; B66C 1/02

(52) U.S. Cl. 248/317; 294/65; 138/111

(57) ABSTRACT

A mounting assembly, particularly suitable for mounting a buoy incorporating an analysis device is disclosed, which conveniently allows a device to be deployed at a remote location from a mounting point and suspended adjacent the mounting point for maintenance.

The present invention relates to apparatus and a method for securing a device, particularly, but not exclusively, a buoy.

The invention is particularly concerned with the problem of securing a device which must be secured for periods of time at some distance from a mounting point but periodically received for inspection or maintenance at a convenient location close to the mounting point.

A simple solution to the above problem would be simply to mount the device on a long arm and to detach the arm at the mounting point when required to retract the device. Whilst this solution would work, retraction of the device may be a hazardous or cumbersome operation, requiring two hands and possibly two people, with the risk that the arm might inadvertently be dropped. A preferred application of the invention is in the mounting of a buoy for the monitoring of waste water, in which the buoy may be mounted many meters below the mounting point. In such a case, in the event that any portion of the mounting assembly were dropped it would be hazardous and an unpleasant task for the operator to retrieve the buoy and/or mounting assembly.

The present invention proposes an elegant solution to the mounting of the device which is less prone to such problems.

In a first aspect, the invention provides apparatus for mounting a buoy comprising a boom for attaching the buoy to a mounting point and a mounting device for the boom movable between a deployed configuration in which the boom extends away from the mounting point towards a deployment zone in which the buoy is to be situated and a service configuration in which the buoy is suspended adjacent the mounting point.

Preferably the boom is detachably secured to the buoy.

Preferably, the boom is secured to the buoy by means of a fixing which also serves as a carrying handle. The fixing may comprise a yoke (which term is intended to encompass a half yoke).

The mounting point may include a mounting rail and the mounting device may be adapted to mount on a mounting rail. The mounting device may comprise a yoke (which term is intended to encompass a half yoke) having a coupling permitting swivel and slide movement of the boom with respect to the yoke.

In a second aspect, the invention provides apparatus for mounting a buoy from a mounting point comprising a first yoke member attached to the buoy;

a boom secured to the first yoke member and a second yoke member attached to the mounting point;

wherein the boom is secured to the second yoke member by means of a coupling which permits sliding of the boom with respect to the second yoke member so that the boom can be retracted to retrieve the device or extended to deploy the device whilst remaining coupled to the second yoke member;

and wherein the second yoke member is movable from a deployed position in which the boom extends towards the zone in which the device is to be deployed and a retracted position in which it supports the device proximate the mounting point for affording access to the device.

In a preferred application, the mounting point comprises a hand rail and the second yoke member is typically mounted on the hand rail, the second yoke member pivoting between said deployed and retracted positions.

Preferably, the apparatus is arranged so that the first yoke member nests within the second yoke member when in the retracted position. Preferably, the first yoke member comprises two arms mounted either side of the device and a base member joining the arms connected to the boom. The arms are preferably pivotally mounted on the device to enable the device to maintain a given orientation substantially independent of the orientation of the boom. Preferably the first yoke member is detectable from the boom to serve as a handle for carrying the device.

Preferably, the second yoke member has two spaced apart arms and base portion, the arms being mounted pivotally on the mounting point. The coupling member is preferably pivotally mounted on the base of the second yoke member to enable the boom to assume an orientation substantially independent of the orientation of the second yoke member.

Although each yoke member preferably comprises two arms, it is possible for either or both yoke members comprise a half yoke having only a single arm.

Preferably, means are provided for securing the boom to inhibit sliding with respect to the second yoke member to retain the device in. either the deployed or retracted condition.

Preferably, the first yoke member and boom are hollow to permit a cable or other control harness to be conducted therethrough for communicating with the device.

An embodiment of the invention will now be described, by way of example, with reference to the accompanying drawing in which:

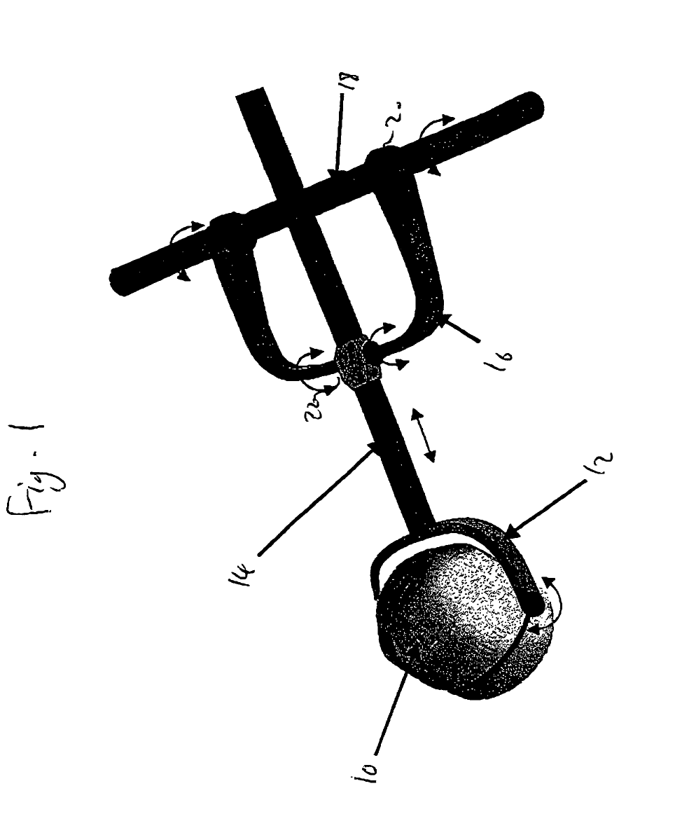

FIG. 1 depicts an embodiment of the mounting assembly in the deployed condition.

Referring to FIG. 1, buoy 10 has a mounting yoke 12 attached to a boom 14 which is coupled by means of a larger yoke 16 to a mounting rail 18. The larger yoke is mounted so as to be able to rotate about the rail by couplings 20 and the boom is mounted so as to be able to rotate relative to the larger yoke 16 by means of coupling 22. The coupling 22 also permits the boom 14 to slide relative to the larger yoke. A locking device, such as a locking screw (not shown) may be provided to prevent sliding of the boom.

The apparatus is shown in the deployed condition. Typically the boom may be at least a couple of meters long (often 3 m or more) and the deployment zone where the buoy is located may be at least a meter or more (typically at least 2 meters) below the mounting point. To service the buoy, the boom 14 is slid through the coupling 22 to raise the buoy. Once the yoke 12 has reached the coupling 22, the entire buoy 10 and yoke 12 are lifted over the mounting rail 18 until the yoke 12 nests within the larger yoke 16 (it will be appreciated that the length and width of the larger yoke must be chosen appropriately to accommodate this) and the locking device may be re-secured so that the buoy is now conveniently suspended for servicing.

The yoke 12 may be detachable from the boom 14 and conveniently the yoke 12 (or other means of securing the boom to the buoy) may also serve as a handle for the buoy.

Although complete yokes are shown, it will be apparent that half yokes or equivalent shapes may be used to achieve the same function, although yokes are preferred for simplicity and stability. The invention is not limited to complete yokes. Other modifications will become apparent to those skilled in the art. The appended abstract is incorporated herein by reference.

1. Apparatus for mounting a buoy comprising a boom for attaching the buoy to a mounting point and a mounting device for the boom movable between a deployed configuration in which the boom extends away from the mounting point towards a deployment zone in which the buoy is to be situated and a service configuration in which the buoy is suspended adjacent the mounting point.

2. Apparatus according to claim 1, wherein the boom is detachably secured to the buoy.

3. Apparatus according to claim 1, wherein the boom is secured to the buoy by means of a fixing which also serves as a carrying handle.

4. Apparatus according to claim 3, wherein the fixing comprises a yoke.

5. Apparatus according to claim 1, wherein the mounting point includes a mounting rail and the mounting device is adapted to mount on the mounting rail.

6. Apparatus according to claim 1, wherein the mounting device comprises a yoke having a coupling permitting swivel and slide movement of the boom with respect to the yoke.

7. Apparatus for mounting a buoy rom a mounting point comprising a first yoke member attached to the buoy;
a boom secured to the first yoke member and a second yoke member attached to the mounting point;
wherein the boom is secured to the second yoke member by means of a coupling which permits sliding of the boom with respect to the second yoke member so that the boom can be retracted to retrieve the device or extended to deploy the device whilst remaining coupled to the second yoke member;
and wherein the second yoke member is movable from a deployed position in which the boom extends towards the zone in which the device is to be deployed and a retracted position in which it supports the device proximate the mounting point for affording access to the device.

8. Apparatus according to claim 1 arranged so that the first yoke member nests within the second yoke member when in the retracted position.

9. Apparatus according to claim 1 including means for securing the boom to inhibit sliding to retain the device in either the deployed or retracted condition.

10. Apparatus according to claim 1 wherein at least the boom is hollow to permit a cable or other control harness to be conducted therethrough for communicating with the device.

11. Apparatus substantially as herein described or as illustrated in the accompanying drawing.
